(19) United States
(12) Patent Application Publication
(10) Pub. No.: US 2019/0286629 A1
(43) Pub. Date: Sep. 19, 2019

(54) METHOD FOR PROCESSING TRANSACTIONS USING BLOCKCHAIN NETWORK, AND TRANSACTION MANAGEMENT SERVER USING THE SAME

(71) Applicant: WAY2BIT Co. Ltd., Seongnam-si (KR)

(72) Inventors: Gyehan SONG, Seongnam-si (KR); Igoo LEE, Seoul (KR); Seoho RYU, Seoul (KR)

(73) Assignee: WAY2BIT Co. Ltd., Seongnam-si (KR)

(21) Appl. No.: 16/299,168

(22) Filed: Mar. 12, 2019

(30) Foreign Application Priority Data
Mar. 13, 2018 (KR) 10-2018-0029458

(51) Int. Cl. G06F 16/23; G06F 16/27; G06F 16/28

(52) U.S. Cl. CPC G06F 16/2379; G06F 16/285; G06F 16/27

(57) ABSTRACT

A method for handling one or more transactions using at least one blockchain network is provided. The method includes steps of: (a) a transaction server, if one or more requests for registering one or more transactions are acquired, confirming storage space of an n-th distributed ledger to register one or more current blocks, corresponding to the transactions, in the n-th distributed ledger which is in an active state; and (b) the transaction server, if the storage space is determined as satisfying at least one preset condition, generating at least one representative block by referring to the transactions in the current blocks registered in the n-th distributed ledger, creating an (n+1)-th distributed ledger whose genesis block is the representative block, and registering one or more next blocks, which are requested for registration after the representative block is registered, in the (n+1)-th distributed ledger.

### CROSS-REFERENCE TO RELATED APPLICATION

The present application claims priority to Korean Patent Application 10-2018-0029458, filed Mar. 13, 2018, the entire contents of which are incorporated herein by reference.

### FIELD OF THE DISCLOSURE

The present disclosure relates to a method for handling one or more transactions using at least one blockchain network; and more particularly, to the method for generating blocks by referring to a distributed ledger and registering blocks in a next distributed ledger, and the server using the same.

### BACKGROUND OF THE DISCLOSURE

Generally, in a transaction processing method using a blockchain network, a method of recording transactions using only one ledger in a blockchain node is used.

In an exemplary conventional transaction processing method shown in FIG. 1, there is no need to manage a separate ledger because only one ledger is used in the blockchain network. However, when such a method is used for a private blockchain network supporting a game service for example, it will process a larger amount of transactions than a public blockchain network. In this case, when an amount of data increases, a problem may occur because the amount of data exceeds an amount of a physical disk that can be managed by a single node.

In addition, even when a plurality of physical disks are used for one blockchain node, there is a problem in that data connection between the disks is hampered and only advantage is a distributed storage.

### SUMMARY OF THE DISCLOSURE

It is an object of the present disclosure to solve all the aforementioned problems.

It is another object of the present disclosure to provide a transaction processing method capable of processing data even in case the data to be processed by a blockchain network for handling a huge amount of transactions exceeds an amount that can be stored by a single ledger.

It is still another object of the present disclosure to prevent sizes of blocks in the blockchain network from exceeding a certain size and improve efficiency of management of blockchain nodes.

It is still yet another object of the present disclosure to provide a method of efficient management of a huge ledger if one blockchain node uses multiple parallel ledgers.

It is still yet another object of the present disclosure to ensure a reliability of ledger data which is a basis of the blockchain network, even when separate multiple ledgers are managed due to a large amount of the transactions.

In accordance with one aspect of the present disclosure, there is provided a method for handling one or more transactions using at least one blockchain network, including steps of: (a) a transaction server, if one or more requests for registering one or more transactions are acquired, confirming storage space of an n-th distributed ledger to register one or more current blocks, corresponding to the transactions, in the n-th distributed ledger which is in an active state; and (b) the transaction server, if the storage space is determined as satisfying at least one preset condition, generating at least one representative block by referring to the transactions in the current blocks registered in the n-th distributed ledger, creating an (n+1)-th distributed ledger whose genesis block is the representative block, and registering one or more next blocks, which are requested for registration after the representative block is registered, in the (n+1)-th distributed ledger.

As one example, at the step of (b), the transaction server generates first summary information on the current blocks registered in the n-th distributed ledger if the preset condition is satisfied, stores one or more additional blocks requested for registering in the n-th distributed ledger in at least one queue, generates second summary information by referring to the additional blocks, and generates the representative block by referring to the first summary information and the second summary information.

As one example, at the step of (b), the preset condition is one of (i) the current blocks in the n-th distributed ledger having a block depth of more than a certain value, (ii) the current blocks in the n-th distributed ledger having a file size of more than a certain size, and (iii) the current blocks in the n-th distributed ledger including data registered during a certain time period.

As one example, at the step of (b), the representative block is generated by summarizing transaction information corresponding to each of addresses registered in the n-th distributed ledger.

As one example, at the step of (b), the representative block is registered in a last one of the current blocks of the n-th distributed ledger.

As one example, at the step of (b), on condition that the n-th distributed ledger has been set as a deactivated distributed ledger which is read-only and that the (n+1)-th distributed ledger has been set as an activated distributed ledger, the transaction server registers said one or more transactions, corresponding to the requests, in the activated distributed ledger.

As one example, at the step of (a), the current blocks including at least one of the transactions, corresponding to the requests which are acquired from services of outside, are registered in each of private blockchain ledgers per each of the services.

In accordance with another aspect of the present disclosure, there is provided a method for handling one or more transactions using at least one blockchain network including steps of: (a) a transaction server, if one or more requests for registering one or more transactions are acquired, registering at least one block including at least one of said one or more transactions in at least one blockchain ledger; (b) the transaction server, if the blockchain ledger satisfies at least one preset condition, generating at least one summary block by referring to the transactions in the block registered in the blockchain ledger; and (c) the transaction server registering the summary block in at least one summary block ledger independent of the blockchain ledger.

As one example, at the step of (b), the summary block is generated via calculating each of balances for each of addresses by referring to transaction information corresponding to each of the addresses registered in the blockchain ledger.

As one example, at the step of (b), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

As one example, at the step of (b), if a 1-st to an n-th distributed ledgers are included in the blockchain network, the transaction server generates the summary block by referring to the transactions in the blocks registered in the 1-st to the n-th distributed ledgers.

As one example, the summary block is generated via calculating each of balances for each of user addresses, by referring to user address information of the transactions in the the blocks registered in the 1-st to the n-th distributed ledgers.

In accordance with still another aspect of the present disclosure, there is provided a method for handling one or more transactions using at least one blockchain network, including steps of: (a) a transaction server, if one or more requests for registering one or more transactions are acquired, registering one or more original blocks including at least one of said one or more transactions in at least one blockchain ledger; (b) the transaction server, if the blockchain ledger satisfies at least one preset condition, sequentially rearranging the transactions by each of user addresses by referring to at least one of the transactions in the original blocks registered in the blockchain ledger, to thereby generate one or more ordered blocks, and registering the ordered blocks in at least one ordered block ledger independent of the blockchain ledger.

As one example, at the step of (b), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

As one example, at the step of (b), the transaction server further generates at least one sequence ledger for registering sequence information on the transactions of the blockchain ledger if the ordered blocks are being registered in the ordered block ledger.

As one example, at the step of (b), if a 1-st to an n-th distributed ledgers are included in the blockchain network, the transaction server generates the ordered blocks by referring to the transactions in the original blocks registered in the 1-st to the n-th distributed ledgers.

As one example, at the step of (b), the ordered blocks registered in the ordered block ledger are generated by classifying the transactions in the original blocks registered in the 1-st to the n-th distributed ledgers by each of the user addresses, and arranging the transactions classified by each of the user addresses according to the user addresses and an order of their corresponding transactions.

In accordance with still yet another aspect of the present disclosure, there is provided a transaction server for handling one or more transactions using at least one blockchain network, including: at least one memory that stores instructions; and at least one processor configured to execute the instructions to perform or support another device to perform processes of: (I) if one or more requests for registering one or more transactions are acquired, confirming storage space of an n-th distributed ledger to register one or more current blocks, corresponding to the transactions, in the n-th distributed ledger which is in an active state, and (II) if the storage space is determined as satisfying at least one preset condition, generating at least one representative block by referring to the transactions in the current blocks registered in the n-th distributed ledger, creating an (n+1)-th distributed ledger whose genesis block is the representative block, and registering one or more next blocks, which are requested for registration after the representative block is registered, in the (n+1)-th distributed ledger.

As one example, at the process of (II), the processor generates first summary information on the current blocks registered in the n-th distributed ledger if the preset condition is satisfied, stores one or more additional blocks requested for registering in the n-th distributed ledger in at least one queue, generates second summary information by referring to the additional blocks, and generates the representative block by referring to the first summary information and the second summary information.

As one example, at the process of (II), the preset condition is one of (i) the current blocks in the n-th distributed ledger having a block depth of more than a certain value, (ii) the current blocks in the n-th distributed ledger having a file size of more than a certain size, and (iii) the current blocks in the n-th distributed ledger including data registered during a certain time period.

As one example, at the process of (II), the representative block is generated by summarizing transaction information corresponding to each of addresses registered in the n-th distributed ledger.

As one example, at the process of (II), the representative block is registered in a last one of the current blocks of the n-th distributed ledger.

As one example, at the process of (II), on condition that the n-th distributed ledger has been set as a deactivated distributed ledger which is read-only and that the (n+1)-th distributed ledger has been set as an activated distributed ledger, the processor registers said one or more transactions, corresponding to the requests, in the activated distributed ledger.

As one example, at the process of (I), the current blocks including at least one of the transactions, corresponding to the requests which are acquired from services of outside, are registered in each of private blockchain ledgers per each of the services.

In accordance with still yet another aspect of the present disclosure, there is provided a transaction server for handling one or more transactions using at least one blockchain network including: at least one memory that stores instructions; and at least one processor configured to execute the instructions to perform or support another device to perform processes of: (I) if one or more requests for registering one or more transactions are acquired, registering at least one block including at least one of said one or more transactions in at least one blockchain ledger, (II) if the blockchain ledger satisfies at least one preset condition, generating at least one summary block by referring to the transactions in the block registered in the blockchain ledger, and (III) registering the summary block in at least one summary block ledger independent of the blockchain ledger.

As one example, at the process of (II), the summary block is generated via calculating each of balances for each of addresses by referring to transaction information corresponding to each of the addresses registered in the blockchain ledger.

As one example, at the process of (II), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

As one example, at the process of (II), if a 1-st to an n-th distributed ledgers are included in the blockchain network, the processor generates the summary block by referring to the transactions in the blocks registered in the 1-st to the n-th distributed ledgers.

As one example, the summary block is generated via calculating each of balances for each of user addresses, by referring to user address information of the transactions in the the blocks registered in the 1-st to the n-th distributed ledgers.

In accordance with still yet another aspect of the present disclosure, there is provided a transaction server for handling one or more transactions using at least one blockchain network, including: at least one memory that stores instructions; and at least one processor configured to execute the instructions to perform or support another device to perform processes of: (a) if one or more requests for registering one or more transactions are acquired, registering one or more original blocks including at least one of said one or more transactions in at least one blockchain ledger, (II) if the blockchain ledger satisfies at least one preset condition, sequentially rearranging the transactions by each of user addresses by referring to at least one of the transactions in the original blocks registered in the blockchain ledger, to thereby generate one or more ordered blocks, and registering the ordered blocks in at least one ordered block ledger independent of the blockchain ledger.

As one example, at the process of (II), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

As one example, at the process of (II), the processor further generates at least one sequence ledger for registering sequence information on the transactions of the blockchain ledger if the ordered blocks are being registered in the ordered block ledger.

As one example, at the process of (II), if a 1-st to an n-th distributed ledgers are included in the blockchain network, the processor generates the ordered blocks by referring to the transactions in the original blocks registered in the 1-st to the n-th distributed ledgers.

As one example, at the process of (II), the ordered blocks registered in the ordered block ledger are generated by classifying the transactions in the the original blocks registered in the 1-st to the n-th distributed ledgers by each of the user addresses, and arranging the transactions classified by each of the user addresses according to the user addresses and an order of their corresponding transactions.

In addition, recordable media that are readable by a computer for storing a computer program to execute the method of the present disclosure is further provided.

### BRIEF DESCRIPTION OF THE DRAWINGS

The above and other objects and features of the present disclosure will become apparent from the following description of preferred embodiments given in conjunction with the accompanying drawings, in which:

FIG. 1 is a drawing schematically illustrating a conventional management method of a ledger in a blockchain node.

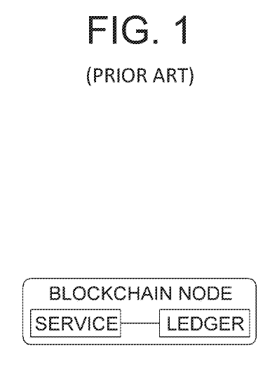

FIG. 2 is a drawing schematically illustrating a configuration of a transaction server in accordance with the present disclosure.

FIG. 3 is a drawing schematically illustrating a management method of parallel ledgers in a blockchain node in accordance with one example embodiment of the present disclosure.

FIG. 4 is a drawing schematically illustrating a process of generating a summary block during management of the parallel ledgers in accordance with one example embodiment of the present disclosure.

FIG. 5 is a drawing schematically illustrating the management method of the parallel ledgers in the blockchain node in accordance with another example embodiment of the present disclosure.

FIG. 6 is a drawing schematically illustrating the management method of the parallel ledgers in the blockchain node in accordance with still another example embodiment of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

Throughout the present disclosure, every processor, every memory, every storage, or any other computing components are described as separate components, however, said every processor, said every memory, said every storage, or said any other computing components may be configured as a single device or any other combinations thereof.

To allow those skilled in the art to the present disclosure to be carried out easily, the example embodiments of the present disclosure by referring to attached diagrams will be explained in detail as shown below.

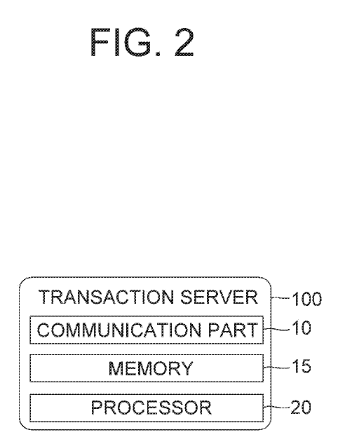

FIG. 2 is a drawing schematically illustrating a configuration of a transaction server in accordance with the present disclosure.

By referring to FIG. 2, the transaction server 100 may include a communication part 10, a memory 15 for storing instructions to handle one or more transactions using at least one blockchain network, and a processor 20 for performing processes to handle the transactions using the blockchain network corresponding to the instructions in the memory 15.

The communication part 10 may receive one or more requests for registering one or more transactions from various external sources. And, in accordance with one example of the present disclosure, the processor 20 may perform or support another device to perform processes of (i) if the requests for registering the transactions are acquired, confirming storage space of an n-th distributed ledger to register one or more current blocks, corresponding to the transactions, in the n-th distributed ledger which is in an active state, and (ii) if the storage space is determined as satisfying at least one preset condition, generating at least one representative block by referring to the transactions in the current blocks registered in the n-th distributed ledger, creating an (n+1)-th distributed ledger whose genesis block is the representative block, and registering one or more next blocks, which are requested for registration after the representative block is registered, in the (n+1)-th distributed ledger.

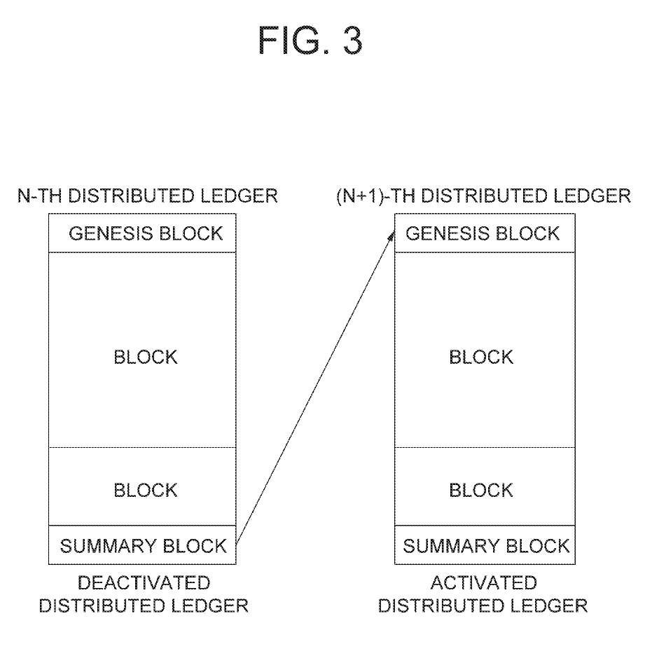

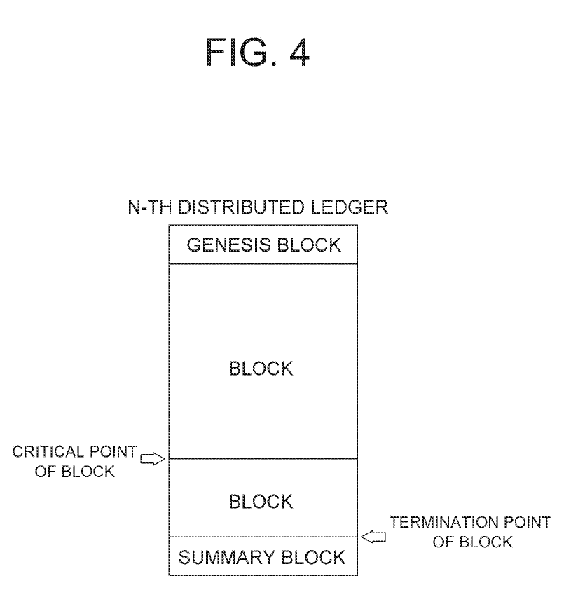

FIG. 3 is a drawing schematically illustrating a management method of parallel ledgers in a blockchain node in accordance with one example embodiment of the present disclosure, and FIG. 4 is a drawing schematically illustrating a process of generating at least one summary block during management of the parallel ledgers in accordance with one example embodiment of the present disclosure.

By referring to FIGS. 3 and 4, the management method of the parallel ledgers in the blockchain node, using the processor 20 of the transaction server 100 in accordance with the present disclosure is described in detail as follows.

By referring to FIG. 3, the blockchain node is shown as including one or more distributed ledgers, and the transaction server 100 may record the current blocks including the transactions in the n-th distributed ledger in the active state while continuously checking the storage space of the n-th distributed ledger, which is in the active state and is currently used for recording, among said one or more distributed ledgers. That is, in accordance with the transaction management method of the present disclosure, if a size of data exceeds a size of free part of the storage space, the distributed ledgers are added so that the distributed ledgers are configured as physically parallel (logically serial).

In one example embodiment of FIG. 3, supposing that all of a 1-st to an (n−1)-th distributed ledgers among the multiple distributed ledgers in a specific blockchain node have been filled, and that the n-th distributed ledger is currently used for recording, the transaction server 100 may confirm the storage space of the n-th distributed ledger, and if the storage space satisfies the preset condition, the representative block may be generated by referring to the transactions included in the current blocks registered in the n-th distributed ledger. In one example embodiment, the representative block may represent summarization of the transactions included in the current blocks registered in the n-th distributed ledger. The representative block, i.e., the summary block, generated as such may be stored in a last one of the current blocks of the n-th distributed ledger. Then, an (n+1)-th distributed ledger, whose genesis block is the summary block, may be generated. And the next blocks including the transactions requested for registering in the specific blockchain node after completion of the summary block of the n-th distributed ledger may be registered in the (n+1)-th distributed ledger.

To explain more specifically, (i) if the current blocks in the n-th distributed ledger are determined as having a block depth of more than a certain depth, (ii) if the current blocks in the n-th distributed ledger is determined as having a file size of more than the certain size, or (iii) if the current blocks in the n-th distributed ledger are determined as including data registered during a certain time period, then the transaction server 100 may generate the representative block by referring to transaction information recorded in the distributed ledger, i.e., the n-th distributed ledger in this example, and may record the representative transaction in the last one of the current blocks of the n-th distributed ledger. For example, the transaction server 100 may summarize information on entire addresses, i.e., accounts, of the transaction information recorded in the n-th distributed ledger, and may record the resulting summary block in the last one of the current blocks of the n-th distributed ledger. Also, the transaction server 100 may open a next distributed ledger for recording, i.e., the (n+1)-th distributed ledger, at a same time of recording the summary block in the n-th distributed ledger, and may record the summary block as the genesis block of the next distributed ledger, i.e., the (n+1)-th distributed ledger.

As a result, each of the distributed ledgers may be connected with one another, and routes may be ensured for backtracking to the connected distributed ledgers using information on a specific transaction.

In accordance with the transaction processing method of the present disclosure, the distributed ledgers may theoretically be expanded in parallel (practically in series having links connecting with one another) ad infinitum. And, the transaction server 100 may set a new distributed ledger for recording as an activated distributed ledger, and may set the distributed ledgers that reached certain limitations as deactivated distributed ledgers which are read-only. That is, the deactivated distributed ledgers may be used as servers or disks optimized for data retrieving.

By referring to FIG. 4, an exemplary process of generating the summary block is described as follows.

First, the transaction server 100 may set at least one critical point of block, i.e., CPOB, regarding the block depth, the file size, or a time period for each of the distributed ledgers, and may monitor the block depth and the storage space of the distributed ledger at stated periods, after generation of the distributed ledger. In this case, the transaction server 100 or a separate processor, e.g., an independent critical point supervisor (not illustrated), may perform monitoring of the block depth, the storage space, or the time period of the distributed ledger. That is, the transaction server 100 or the separate processor may monitor whether the current blocks including at least one registered transaction reach the CPOB. If the registered current blocks reach the CPOB, the transaction server 100 may generate first summary information on the registered current blocks in the n-th distributed ledger. The first summary information may be summary information on all of addresses of the transactions recorded from a last point of the genesis block of the n-th distributed ledger to the CPOB. And, at least one queue including one or more additional blocks requested for registration may be alloted for the additional blocks including at least one additional transaction recorded after the CPOB of the n-th distributed ledger is reached. The transaction server 100 may also generate second summary information on the additional blocks including at least one of the additional transactions corresponding to the queue. It is preferable that the second summary information be generated right after generation of the first summary information is completed.

And if the last block of the n-th distributed ledger, i.e., a termination point of block (TPOB) where the summary block starts, is reached, the transaction server 100 may generate and record the summary block, by referring to the first summary information and the second summary information, as the last block of the n-th distributed ledger.

As a result, in the blockchain node, a large amount of data may be recorded by using the distributed ledgers connected in sequence, without regard to limited amount of physical disks.

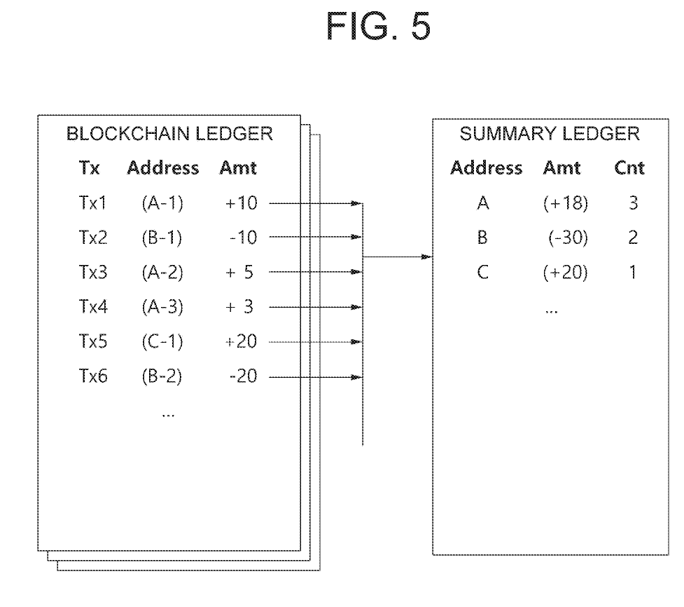

FIG. 5 is a drawing schematically illustrating the management method of the parallel ledgers in the blockchain node in accordance with another example embodiment of the present disclosure.

Another example embodiment of FIG. 5 also shows a configuration of the blockchain node including the multiple distributed ledgers. Also, a method of generating the summary block which represents summarization of contents of the multiple distributed ledgers and registering the summary block in a summary ledger independent of the multiple distributed ledgers.

By referring to FIG. 5, if one or more requests for registering one or more transactions are acquired, the transaction server may register at least one block including at least one of said one or more transactions in one or more blockchain ledgers. On condition that the block including at least one of the transactions has been registered in the blockchain ledgers, if a specific blockchain ledger among the blockchain ledgers satisfies at least one preset condition, the transaction server may generate at least one summary block by referring to the transactions in the blocks registered in the blockchain ledgers. The preset condition may include one of (i) the number of the transactions registered in the blockchain ledgers exceeding a certain value, for example, a counting number of the transactions exceeding one hundred, (ii) an interval from registration of a specific transaction registered most recently among the transactions to acquisition of any of the requests after the registration exceeding a certain time interval, for example, one week having passed since registration of the last transaction, and (iii) a new blockchain ledger, branching from the blockchain ledgers, being created.

Then the transaction server may register the summary block in the summary ledger independent of the blockchain ledgers.

For example, the transaction server may generate the summary blocks via calculating each of balances for each of the addresses by referring to transaction information corresponding to each of the addresses registered in the blockchain ledgers.

Also, if the blockchain network includes the multiple distributed ledgers, e.g., the 1-st to the n-th distributed ledgers, the transaction server may generate the summary block which refers to the transactions included in the blocks registered in the 1-st to the n-th distributed ledgers, that is, generate the summary blocks via calculating each of the balances per each of the addresses by referring to the user addresses of the transactions included in the blocks registered in each of the distributed ledgers, i.e., the 1-st to the n-th distributed ledgers.

By referring to FIG. 5, if Tx1 with an amount, i.e., balance, of +10 is recorded at an address of (A-1), Tx2 with a balance of −10 is recorded at an address of (B-1), Tx3 with a balance of +5 is recorded at an address of (A-2), Tx4 with a balance of +3 is recorded at an address of (A-3), Tx5 with a balance of +20 is recorded at an address of (C-1), and Tx6 with a balance of −20 is recorded at an address of (B-2) in a specific distributed ledger, then the summary block may include information on a result of calculating each of the balances per each of the addresses corresponding to each of users A, B, and C. In another example embodiment of FIG. 5, the summary block may be generated such that a count value, i.e., Cnt, represents a fact that the balance at the address A equals +18 resulting from a summation of +10, +5, and +3 and a fact that three of the transactions are summarized, a count value represents a fact that the balance at the address B equals −30 resulting from a summation of −10 and −20 and a fact that two of the transactions are summarized, and a count value represents a fact that the balance at the address C equals +20 and a fact that one of the transactions is summarized.

Meanwhile, the multiple distributed ledgers may be managed per storage space of the certain size if the preset condition is about one of the block depth and the certain size, or may be managed per each certain time period if the preset condition is about time periods of the data. For example, if the preset condition is about the time periods, a first distributed ledger may be a distributed ledger including data in 2015, a second distributed ledger may be a distributed ledger including data in 2016, a third distributed ledger may be a distributed ledger including data in 2017, and a fourth distributed ledger may be a distributed ledger including data in 2018. In this case, maintaining multiple separate distributed ledgers alone may not provide reliability of past data, however, maintaining one or more of the summary ledgers in accordance with the present disclosure may provide the reliability of the past data guaranteed by the blockchain network.

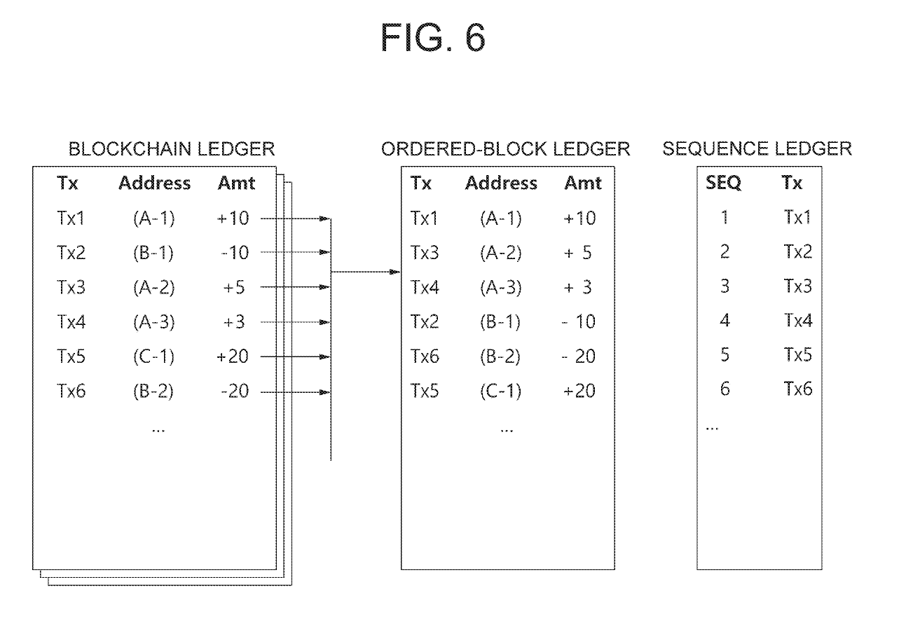

FIG. 6 is a drawing schematically illustrating the management method of the parallel ledgers in the blockchain node in accordance with still another example embodiment of the present disclosure.

FIG. 6 also shows a configuration of the blockchain node including the multiple distributed ledgers. Also, a method of managing the separate ordered-block ledger by rearranging transactions for each of the addresses to improve summarizing efficiency of contents of the multiple distributed ledgers and registering the rearranged transactions in the ordered-block ledger independent of the blockchain ledgers is proposed.

By referring to FIG. 6, if one or more requests for registering one or more transactions are acquired, the transaction server may register at least one original block including at least one of said one or more transactions in one or more blockchain ledgers. On condition that the original block including at least one of the transactions has been registered in the blockchain ledgers as such, if a specific blockchain ledger among the blockchain ledgers satisfies at least one preset condition, the transaction server may sequentially rearrange the transactions by each of the user addresses by referring to at least one of the transactions in the original block registered in the specific blockchain ledger, to thereby generate one or more ordered blocks, and may register the ordered blocks in a specific ordered-block ledger independent of the specific blockchain ledger. Herein, the preset condition may be identical to or different from that of said another example embodiment of FIG. 5. That is, the preset condition may include one of (i) the number of the transactions registered in the specific blockchain ledger exceeding a certain value, for example, a counting number of the transactions exceeding one hundred, (ii) an interval from registration of a specific transaction registered most recently among the transactions to acquisition of any of the requests after the registration exceeding a certain time interval, for example, one week having passed since registration of the last transaction, and (iii) a new blockchain ledger, branching from the specific blockchain ledger, being created.

By referring to FIG. 6, if Tx1 with an amount, i.e., balance, of +10 is recorded at an address of (A-1), Tx2 with a balance of −10 is recorded at an address of (B-1), Tx3 with a balance of +5 is recorded at an address of (A-2), Tx4 with a balance of +3 is recorded at an address of (A-3), Tx5 with a balance of +20 is recorded at an address of (C-1), and Tx6 with a balance of −20 is recorded at an address of (B-2) in a specific distributed ledger, then these may be classified and rearranged in an order for each of the users, that is, A-1, A-2, A-3 for the user A, B-1, B-2 for the user B, and C-1 for the user C in the specific ordered-block ledger. Accordingly, the transactions recorded in the distributed ledger in the order of Tx1, Tx2, Tx3, Tx4, Tx5, and Tx6 may be rearranged and recorded in the specific ordered-block ledger in the order of Tx1, Tx3, Tx4, Tx2, Tx6, and Tx5.

If the transactions are rearranged per address as such, compression efficiency may be improved when generating the summary block and also data-searching time may be minimized, by collecting the transactions for a same account, i.e., address, as many as possible, for storing.

Meanwhile, in still another example embodiment of the present disclosure, a specific sequence ledger is managed in addition to the specific ordered-block ledger, and the specific sequence ledger may manage the order of the transactions, and may reproduce the transactions if needed. The additional specific sequence ledger may be generated when the ordered blocks are registered in the specific ordered-block ledger or thereafter, and may be used to register ordering information of the transactions included in the specific blockchain ledger. By referring to FIG. 6, the specific sequence ledger may allocate the order 1, 2, 3, 4, 5, 6, etc. to the transactions Tx1, Tx2, Tx3, Tx4, Tx5, Tx6, etc. included in the distributed ledger at a left hand side and store the transactions with their allocated orders.

Meanwhile, the multiple distributed ledgers in still another example embodiment of FIG. 6 may be maintained in a time-distributive manner as in FIG. 5. If the 1-st to the n-th distributed ledgers are assumed to be included in the blockchain network, the transaction server may generate the ordered blocks by referring to the transactions in the the blocks registered in the 1-st to the n-th distributed ledgers. As one example, the ordered blocks registered in the ordered-block ledger may be generated by classifying the transactions in the the blocks registered in the 1-st to the n-th distributed ledgers by each of the user addresses, and arranging the transactions classified by each of the user addresses according to the user addresses and the order of their corresponding transactions.

Thereafter, the summary block may be generated by using the ordered-block ledger having the transactions rearranged per user address. Therefore, maintaining the ordered-block ledger and the summary ledger may provide the reliability even of the past data guaranteed by the blockchain network.

Each of the ledgers like the summary ledger, the sequence ledger, the ordered-block ledger disclosed in the present disclosure is represented as a singular form, however, multiple of the ledgers, i.e., the summary ledgers, the sequence ledgers, the ordered-block ledgers, may be generated as the case may be. Also, the address or the addresses may include the user address or the user addresses, but the scope of the present disclosure is not limited thereto.

In the present disclosure, large-scaled parallel ledgers are managed by operating the summary ledger which records summarization of the data stored in the multiple parallel ledgers, and the reliability even of the past data guaranteed by the blockchain network may be provided, when the multiple parallel ledgers are used for a single blockchain node.

The present disclosure has an effect of providing processing capability even in case an amount of data, to be processed in a blockchain network for handling many transactions, exceeds an amount that can be stored by a single ledger, by using the multiple distributed ledgers connected in parallel with the single blockchain node.

The present disclosure has another effect of preventing sizes of the blocks of the blockchain network exceeding the certain size and improving efficiency of management of the blockchain nodes by managing the large-scaled parallel ledgers capable of storing large amount of data in the single blockchain node.

The present disclosure has still another effect of managing the large-scaled parallel ledgers by operating the summary ledger which records the summarization of the data stored in the multiple parallel ledgers, when the multiple parallel ledgers are used for the single blockchain node.

The present disclosure has still yet another effect of improving the compression efficiency of the data by operating an independent ledger which includes the transactions, stored in each of the distributed ledgers, that are rearranged for each address, when the multiple parallel ledgers are used for the single blockchain node.

The present disclosure has still yet another effect of providing the reliability of ledger data which is a basis of the blockchain network, even when the separate multiple ledgers are managed due to large amount of the transactions.

The embodiments of the present disclosure as explained above can be implemented in a form of executable program command through a variety of computer means recordable to computer readable media. The computer readable media may include solely or in combination, program commands, data files, and data structures. The program commands recorded to the media may be components specially designed for the present disclosure or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a complier but also a high level code that can be used by an interpreter etc., which is executed by a computer. The aforementioned hardware device can work as more than a software module to perform the action of the present disclosure and they can do the same in the opposite case.

As seen above, the present disclosure has been explained by specific matters such as detailed components, limited embodiments, and drawings. They have been provided only to help more general understanding of the present disclosure. It, however, will be understood by those skilled in the art that various changes and modification may be made from the description without departing from the spirit and scope of the disclosure as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method of handling one or more transactions using at least one blockchain network, comprising steps of:
(a) a transaction server, if one or more requests for registering one or more transactions are acquired, confirming storage space of an n-th distributed ledger to register one or more current blocks, corresponding to the transactions, in the n-th distributed ledger which is in an active state; and
(b) the transaction server, if the storage space is determined as satisfying at least one preset condition, generating at least one representative block by referring to the transactions in the current blocks registered in the n-th distributed ledger, creating an (n+1)-th distributed ledger whose genesis block is the representative block, and registering one or more next blocks, which are requested for registration after the representative block is registered, in the (n+1)-th distributed ledger.

2. The method of claim 1, wherein, at the step of (b), the transaction server generates first summary information on the current blocks registered in the n-th distributed ledger if the preset condition is satisfied, stores one or more additional blocks requested for registering in the n-th distributed ledger in at least one queue, generates second summary information by referring to the additional blocks, and generates the representative block by referring to the first summary information and the second summary information.

3. The method of claim 1, wherein, at the step of (b), the preset condition is one of (i) the current blocks in the n-th distributed ledger having a block depth of more than a certain value, (ii) the current blocks in the n-th distributed ledger having a file size of more than a certain size, and (iii) the current blocks in the n-th distributed ledger including data registered during a certain time period.

4. The method of claim 1, wherein, at the step of (b), the representative block is generated by summarizing transaction information corresponding to each of addresses registered in the n-th distributed ledger.

5. The method of claim 1, wherein, at the step of (b), the representative block is registered in a last one of the current blocks of the n-th distributed ledger.

6. The method of claim 1, wherein, at the step of (b), on condition that the n-th distributed ledger has been set as a deactivated distributed ledger which is read-only and that the (n+1)-th distributed ledger has been set as an activated distributed ledger, the transaction server registers said one or more transactions, corresponding to the requests, in the activated distributed ledger.

7. The method of claim 1, wherein, at the step of (a), the current blocks including at least one of the transactions, corresponding to the requests which are acquired from services of outside, are registered in each of private blockchain ledgers per each of the services.

8. A method of handling one or more transactions using at least one blockchain network, comprising steps of:
(a) a transaction server, if one or more requests for registering one or more transactions are acquired, registering at least one block including at least one of said one or more transactions in at least one blockchain ledger;
(b) the transaction server, if the blockchain ledger satisfies at least one preset condition, generating at least one summary block by referring to the transactions in the block registered in the blockchain ledger; and
(c) the transaction server registering the summary block in at least one summary block ledger independent of the blockchain ledger.

9. The method of claim 8, wherein, at the step of (b), the summary block is generated via calculating each of balances for each of addresses by referring to transaction information corresponding to each of the addresses registered in the blockchain ledger.

10. The method of claim 8, wherein, at the step of (b), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

11. The method of claim 8, wherein, at the step of (b), if a 1-st to an n-th distributed ledgers are included in the blockchain network, the transaction server generates the summary block by referring to the transactions in the blocks registered in the 1-st to the n-th distributed ledgers.

12. The method of claim 11, wherein the summary block is generated via calculating each of balances for each of user addresses, by referring to user address information of the transactions in the the blocks registered in the 1-st to the n-th distributed ledgers.

13. A method of handling one or more transactions using at least one blockchain network, comprising steps of:
(a) a transaction server, if one or more requests for registering one or more transactions are acquired, registering one or more original blocks including at least one of said one or more transactions in at least one blockchain ledger;
(b) the transaction server, if the blockchain ledger satisfies at least one preset condition, sequentially rearranging the transactions by each of user addresses by referring to at least one of the transactions in the original blocks registered in the blockchain ledger, to thereby generate one or more ordered blocks, and registering the ordered blocks in at least one ordered block ledger independent of the blockchain ledger.

14. The method of claim 13, wherein, at the step of (b), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

15. The method of claim 13, wherein, at the step of (b), the transaction server further generates at least one sequence ledger for registering sequence information on the transactions of the blockchain ledger if the ordered blocks are being registered in the ordered block ledger.

16. The method of claim 13, wherein, at the step of (b), if a 1-st to an n-th distributed ledgers are included in the blockchain network, the transaction server generates the ordered blocks by referring to the transactions in the original blocks registered in the 1-st to the n-th distributed ledgers.

17. The method of claim 16, wherein, at the step of (b), the ordered blocks registered in the ordered block ledger are generated by classifying the transactions in the the original blocks registered in the 1-st to the n-th distributed ledgers by each of the user addresses, and arranging the transactions classified by each of the user addresses according to the user addresses and an order of their corresponding transactions.

18. A transaction server for handling one or more transactions using at least one blockchain network, comprising:
at least one memory that stores instructions; and
at least one processor configured to execute the instructions to perform or support another device to perform processes of: (I) if one or more requests for registering one or more transactions are acquired, confirming storage space of an n-th distributed ledger to register one or more current blocks, corresponding to the transactions, in the n-th distributed ledger which is in an active state, and (II) if the storage space is determined as satisfying at least one preset condition, generating at least one representative block by referring to the transactions in the current blocks registered in the n-th distributed ledger, creating an (n+1)-th distributed ledger whose genesis block is the representative block, and registering one or more next blocks, which are requested for registration after the representative block is registered, in the (n+1)-th distributed ledger.

19. The transaction server of claim 18, wherein, at the process of (II), the processor generates first summary information on the current blocks registered in the n-th distributed ledger if the preset condition is satisfied, stores one or more additional blocks requested for registering in the n-th distributed ledger in at least one queue, generates second summary information by referring to the additional blocks, and generates the representative block by referring to the first summary information and the second summary information.

20. The transaction server of claim 18, wherein, at the process of (II), the preset condition is one of (i) the current blocks in the n-th distributed ledger having a block depth of more than a certain value, (ii) the current blocks in the n-th distributed ledger having a file size of more than a certain size, and (iii) the current blocks in the n-th distributed ledger including data registered during a certain time period.

21. The transaction server of claim 18, wherein, at the process of (II), the representative block is generated by summarizing transaction information corresponding to each of addresses registered in the n-th distributed ledger.

22. The transaction server of claim 18, wherein, at the process of (II), the representative block is registered in a last one of the current blocks of the n-th distributed ledger.

23. The transaction server of claim 18, wherein, at the process of (II), on condition that the n-th distributed ledger has been set as a deactivated distributed ledger which is read-only and that the (n+1)-th distributed ledger has been set as an activated distributed ledger, the processor registers said one or more transactions, corresponding to the requests, in the activated distributed ledger.

24. The transaction server of claim 18, wherein, at the process of (I), the current blocks including at least one of the transactions, corresponding to the requests which are acquired from services of outside, are registered in each of private blockchain ledgers per each of the services.

25. A transaction server for handling one or more transactions using at least one blockchain network, comprising:
at least one memory that stores instructions; and
at least one processor configured to execute the instructions to perform or support another device to perform processes of: (I) if one or more requests for registering one or more transactions are acquired, registering at least one block including at least one of said one or more transactions in at least one blockchain ledger, (II) if the blockchain ledger satisfies at least one preset condition, generating at least one summary block by referring to the transactions in the block registered in the blockchain ledger, and (III) registering the summary block in at least one summary block ledger independent of the blockchain ledger.

26. The transaction server of claim 25, wherein, at the process of (II), the summary block is generated via calculating each of balances for each of addresses by referring to transaction information corresponding to each of the addresses registered in the blockchain ledger.

27. The transaction server of claim 25, wherein, at the process of (II), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

28. The transaction server of claim 25, wherein, at the process of (II), if a 1-st to an n-th distributed ledgers are included in the blockchain network, the processor generates the summary block by referring to the transactions in the blocks registered in the 1-st to the n-th distributed ledgers.

29. The transaction server of claim 28, wherein the summary block is generated via calculating each of balances for each of user addresses, by referring to user address information of the transactions in the blocks registered in the 1-st to the n-th distributed ledgers.

30. A transaction server for handling one or more transactions using at least one blockchain network, comprising:
at least one memory that stores instructions; and
at least one processor configured to execute the instructions to perform or support another device to perform processes of: (a) if one or more requests for registering one or more transactions are acquired, registering one or more original blocks including at least one of said one or more transactions in at least one blockchain ledger, (II) if the blockchain ledger satisfies at least one preset condition, sequentially rearranging the transactions by each of user addresses by referring to at least one of the transactions in the original blocks registered in the blockchain ledger, to thereby generate one or more ordered blocks, and registering the ordered blocks in at least one ordered block ledger independent of the blockchain ledger.

31. The transaction server of claim 30, wherein, at the process of (II), the preset condition includes one of the number of the transactions registered in the blockchain ledger exceeding a certain value, an interval from registration of a specific transaction registered most recently among the transactions to acquisition of any of the requests after the registration exceeding a certain time interval, and a new blockchain ledger, branching from the blockchain ledger, being created.

32. The transaction server of claim 30, wherein, at the process of (II), the processor further generates at least one sequence ledger for registering sequence information on the transactions of the blockchain ledger if the ordered blocks are being registered in the ordered block ledger.

33. The transaction server of claim 30, wherein, at the process of (II), if a 1-st to an n-th distributed ledgers are included in the blockchain network, the processor generates the ordered blocks by referring to the transactions in the original blocks registered in the 1-st to the n-th distributed ledgers.

34. The transaction server of claim 33, wherein, at the process of (II), the ordered blocks registered in the ordered block ledger are generated by classifying the transactions in the the original blocks registered in the 1-st to the n-th distributed ledgers by each of the user addresses, and arranging the transactions classified by each of the user addresses according to the user addresses and an order of their corresponding transactions.
